(19) United States
(12) Patent Application Publication
(10) Pub. No.: US 2021/0017711 A1
(43) Pub. Date: Jan. 21, 2021

(54) FIBER STRUCTURAL BODY AND METHOD FOR MANUFACTURING THE SAME

(71) Applicant: SEIKO EPSON CORPORATION, Tokyo (JP)

(72) Inventors: Shinobu YOKOKAWA, Okaya (JP); Hideki TANAKA, Chino (JP); Tetsuya AOYAMA, Shiojiri (JP)

(21) Appl. No.: 16/929,188

(22) Filed: Jul. 15, 2020

(30) Foreign Application Priority Data
Jul. 17, 2019 (JP) 2019-131748

(51) Int. Cl. D21H 17/22; C08J 3/24; D21H 11/20; D21H 21/06; D21F 9/00

(52) U.S. Cl. CPC D21H 17/22; C08J 3/242; D21H 11/20; C08J 2489/00; D21F 9/00; C08J 2301/02; D21H 21/06

(57) ABSTRACT

A fiber structural body includes fibers and a fibroin which binds the fibers, and when the fibers are represented by A, and the fibroin is represented by B, the following formulas (1) and (2) are satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

The present application is based on, and claims priority from JP Application Serial Number 2019-131748, filed Jul. 17, 2019, the disclosure of which is hereby incorporated by reference herein in its entirety.

### BACKGROUND

### 1. Technical Field

The present disclosure relates to a fiber structural body and a method for manufacturing the same.

### 2. Related Art

JP-A-2010-95596 has disclosed a silk fibroin composite material in which a silk fibroin is impregnated in a fiber material.

JP-A-2007-277481 has disclosed a method for manufacturing a thermal conductor containing a silk protein.

JP-A-2015-214132 has disclosed a method for manufacturing a fibroin composite composed of a fiber support and a fibroin porous body.

International Publication No. 2017/030197A1 has disclosed a method for manufacturing a polypeptide composition having a fibroin-like structure.

In recent years, in fields of dry-type waste-paper recycling techniques, in order to reduce an environmental load, a binding material to be used to bind fibers to each other has been desired to be converted from a petroleum-derived material to a naturally-derived material. However, when the naturally-derived material is used, there has been a problem in that a tensile strength and/or a folding resistance of recycle paper is difficult to secure.

### SUMMARY

According to an aspect of the present disclosure, there is provided a fiber structural body which comprises: fibers; and a fibroin which binds the fibers, and when the fibers are represented by A, and the fibroin is represented by B, the following formulas (1) and (2) are satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

The fibers of the fiber structural body may be at least one selected from natural fibers and chemical fibers.

The fibroin of the fiber structural body may be at least one selected from a material produced by an arthropod or its larva, a material derived therefrom, and an artificially produced material.

The fibers of the fiber structural body each may have at least one of a hydroxy group, an amino group, and a carbonyl group on its surface.

In the fiber structural body, the average width of the fibers in the short direction may be 1 to 100 μm.

In the fiber structural body, the fibers may have a density of 0.1 to 2.0 g/cm³.

According to another aspect of the present disclosure, there is provided a method for manufacturing a fiber structural body, which comprises: a mixing step of mixing fibers and a fibroin which binds the fibers to form a fiber body; a web forming step of depositing the fiber body in air to form a web; an aqueous solution applying step of applying an aqueous solution to the web; and a forming step of pressurizing and heating the web to which the aqueous solution is applied to form a fiber structural body. In the mixing step, when the fibers are represented by A, and the fibroin is represented by B, the following formulas (1) and (2) are satisfied, and in the aqueous solution applying step, when moisture contained in the fiber structural body after the aqueous solution application is represented by C, the following formula (3) is satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

0.2≤mass of C/(dry mass of A with respect to total mass of fiber structural body+dry mass of B with respect to total mass of fiber structural body≤10.0 (3)

According to still another aspect of the present disclosure, there is provided a method for manufacturing a fiber structural body, which comprises: a web forming step of depositing a fiber body containing fibers in air to form a web; an aqueous solution applying step of applying an aqueous solution containing a fibroin to the web; and a forming step of pressurizing and heating the web to which the aqueous solution is applied to form a fiber structural body. In the aqueous solution applying step, when the fibers are represented by A, the fibroin is represented by B, and moisture contained in the fiber structural body after the aqueous solution application is represented by C, the following formulas (1) and (2) are satisfied.

0.01≤dry mass of B with respect to total mass of fiber structural body/(dry mass of A with respect to total mass of fiber structural body+dry mass of B with respect to total mass of fiber structural body)≤0.40 (1)

0.2≤mass of C/(dry mass of A with respect to total mass of fiber structural body+dry mass of B with respect to total mass of fiber structural body≤10.0 (2)

The method for manufacturing a fiber structural body described above may further comprise, before the aqueous solution applying step, a hydrophilic treatment step of performing a hydrophilic treatment on the surfaces of the fibers.

According to yet another aspect of the present disclosure, there is provided a method for manufacturing a fiber structural body, which comprises: a filling step of filling a mixture in which fibers, a fibroin which binds the fibers, and an aqueous solution are mixed together in a molding die; and a forming step of pressurizing and heating the filled mixture to form a fiber structural body. In the filling step, when the fibers are represented by A, the fibroin is represented by B, and moisture contained in the fiber structural body after the aqueous solution application is represented by C, the following formulas (1), (2), and (3) are satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

0.2≤mass of C/(dry mass of A with respect to total mass of fiber structural body+dry mass of B with respect to total mass of fiber structural body≤10.0 (3)

In the forming step of the method for manufacturing a fiber structural body, a pressure to be applied may be 10 to 80 MPa.

In the forming step of the method for manufacturing a fiber structural body, a temperature to be applied may be 80° C. to 230° C.

In the method for manufacturing a fiber structural body, the aqueous solution may contain, besides water, one of alcohols including methyl alcohol, ethyl alcohol, isopropyl alcohol, butanol, and hexanediol and glycols including glycerin, ethylene glycol, propylene glycol, diethylene glycol, triethylene glycol, a polyethylene glycol, butylene glycol, and thiodiglycol.

### BRIEF DESCRIPTION OF THE DRAWINGS

FIG. 1 is a schematic view showing the structure of a fiber structural body according to Embodiment 1.

FIG. 2 is another schematic view showing the structure of the fiber structural body according to Embodiment 1.

FIG. 3 is a flowchart showing a method for manufacturing the fiber structural body according to Embodiment 1.

FIG. 4 is a schematic view showing the structure of a manufacturing apparatus which manufactures the fiber structural body according to Embodiment 1.

FIG. 5 is a flowchart showing a method for manufacturing a fiber structural body according to Embodiment 2.

FIG. 6 is a schematic view showing the structure of a manufacturing apparatus which manufactures the fiber structural body according to Embodiment 2.

FIG. 7 is a flowchart showing a method for manufacturing a fiber structural body according to Embodiment 3.

FIG. 8 is a schematic view showing the method for manufacturing the fiber structural body according to Embodiment 3 and the structure of a manufacturing apparatus therefor.

FIG. 9 is another schematic view showing the method for manufacturing the fiber structural body according to Embodiment 3 and the structure of the manufacturing apparatus therefor.

### DESCRIPTION OF EXEMPLARY EMBODIMENTS

### 1. Embodiment 1

First, the structure of a fiber structural body S will be described.

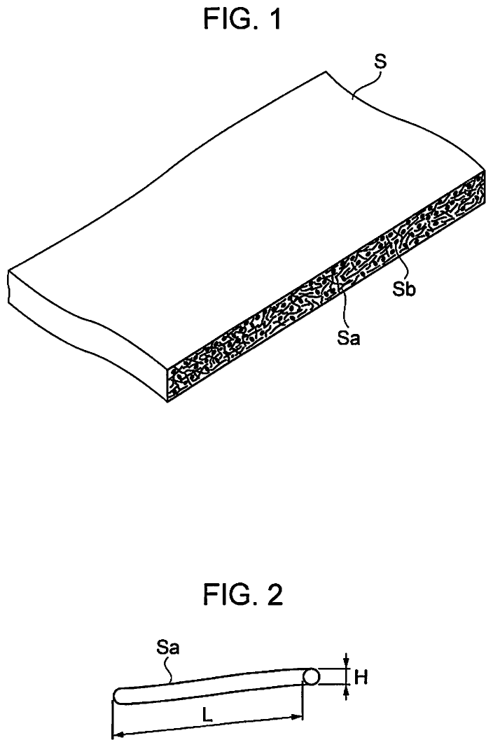

FIGS. 1 and 2 are each a schematic view showing the structure of the fiber structural body S. In particular, FIG. 1 is a schematic cross-sectional view showing the structure of the fiber structural body S, and FIG. 2 is a schematic view showing one example of the shape of a fiber Sa.

As shown in FIG. 1, the fiber structural body S includes fibers Sa and a fibroin Sb which binds the fibers Sa. The fiber structural body S has a sheet shape. In this case, when the fibers Sa are represented by A, and the fibroin Sb is represented by B, the following formulas (1) and (2) are satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

In addition, in more preferable, 0.5≤volume average particle diameter of B/average width of A in short direction≤2.00 is satisfied, and 0.10≤dry mass of B with respect to total mass of fiber structural body/(dry mass of A with respect to total mass of fiber structural body+dry mass of B with respect to total mass of fiber structural body)≤0.20 is satisfied. In addition, the average width of the fibers Sa in the short direction indicates a dimension H shown in FIG. 2. In addition, in the present disclosure, the dry mass indicates a mass in a dry state in which water is not present after being evaporated at a temperature of 100° C. to 110° C.

As shown in FIG. 2, the fiber Sa has a thread shape. In addition, when a longitudinal direction dimension and a short direction dimension of the fiber Sa are represented by L and H, respectively, the average width of A in the short direction of the above formula (1) indicates the dimension H.

Since the fibers Sa are bound to each other with the naturally-derived fibroin Sb, compared to the case in the past in which a petroleum-derived synthetic resin was used as a binding material, the environmental load is reduced. In particular, an emission amount of carbon dioxide, for example, by the production of petroleum-derived synthetic resins can be reduced. Furthermore, when the conditions of the above formulas (1) and (2) are satisfied, a fiber structural body S which can ensure the tensile strength and the folding resistance can be provided. That is, when the fiber structural body S is paper, besides the reduction in environmental load, inherent strength and flexibility of paper can be obtained.

A raw material of the fibers Sa is not particularly limited, and various fiber materials may be used. As the fibers, for example, natural fibers (animal fibers and plant fibers) and chemical fibers (organic fibers, inorganic fibers, and organic-inorganic composite fibers) may be mentioned. In more particular, for example, there may be mentioned pulp fibers formed from a cellulose, a silk, a wool, a cotton, a hemp, a kenaf, a flax, a ramie, a jute, a Manila hemp, a Sisal hemp, a coniferous tree, or a broadleaf tree; and fibers formed from a rayon, a viscose rayon, a Lyocell, a cupra, a vinylon, an acrylic resin, a nylon, an aramid, a polyester, a polyethylene, a polypropylene, a polyurethane, a polyimide, a poly(ethylene terephthalate), a polyamide, a carbon, a glass, a metal, or an asbestos, and those fibers may be used alone, may be appropriately mixed together, or may be used as regenerated fibers after being refined or the like. As the raw material, for example, although waste paper, waste cloth, and the like may be mentioned, at least one type of those fibers may be contained in the raw material. In addition, the fibers may be dried, may contain a liquid, such as water or an organic solvent, or may be impregnated with the liquid mentioned above. In addition, various surface treatments may be performed on the fibers. In addition, a material of the fibers may be a pure material or a material containing a plurality of components, such as an impurity, an additive, and/or other components. In view of the reduction in environmental load, natural fibers are preferably used. When various fibers Sa are bound to each other with the fibroin Sb, various types of fiber structural bodies S can be formed.

The fibers of the fiber structural body S each have at least one of a hydroxy group, an amino group, and a carbonyl group on its surface. In this case, for example, the fiber of the fiber structural body S may have only a hydroxy group on its surface or may have a hydroxy group together with at least one different group thereon. Accordingly, a binding force between the fibers Sa can be increased. In addition, the average width H of the fibers Sa in the short direction is 1 to 100 μm. Furthermore, in the fiber structural body S, the density of the fibers Sa is 0.1 to 2.0 g/cm³. Accordingly, the tensile strength and the folding resistance of the fiber structural body S can be further increased.

The fibroin Sb is at least one selected from a material produced by an arthropod or its larva, a material derived therefrom, and an artificially produced material. The fibroin Sb has a biodegradable property and can further reduce the environmental load. The arthropod includes, for example, order araneae, and as the larvae of arthropods, a silkworm, a bagworm, and the like may be mentioned. In addition, besides fibroins derived from natural spiders, a polypeptide composition having a fibroin-like structure obtained by applying an in vivo production mechanism of a natural spider dragline to manufacturing of man-made fibers and/or artificial fibers may also be used. In addition, the fibroin Sb may be a mixture in which the materials mentioned above are appropriately mixed together. The fibroin Sb has, for example, particle shapes, and particles having a predetermined diameter can be obtained by pulverization. The pulverization may be performed using a pulverizing machine, such as a hammer mill, a pin mill, a cutter mill, a pulverizer, a turbo mill, a disc mill, a screen mill, or a jet mill. The particles can be obtained by using those pulverizing machines in appropriate combination. In addition, a pulverization step may be performed in a stepwise manner such that after rough pulverization is performed to have particles having a particle diameter of approximately 1 mm, fine pulverization is performed to have particles having a target particle diameter. In the case as described above, at each stage, a machine appropriately selected from those mentioned above by way of example may be used. In order to further increase the efficiency of the pulverization, a freeze pulverization method may also be used. Since the fibroin Sb thus obtained may contain particles having various sizes in some cases, in order to obtain particles having a target particle diameter, if needed, classification may be performed using a known classification machine. The particle diameter (volume average particle diameter) of the particles of the fibroin Sb is preferably 0.1 to 100 μm, more preferably 1 to 60 μm, and further preferably 1 to 40 μm.

The volume average particle diameter of the fibroin Sb can be measured, for example, by a particle size distribution measurement device using a laser diffraction scattering method as a measurement principle. As the particle size distribution measurement device, for example, a laser diffraction particle size distribution measurement device “SALD-2300” manufactured by Shimadzu Corporation may be mentioned.

In addition, besides the fibroin Sb, if needed, a natural resin or a synthetic resin may also be contained as the binding material which binds the fibers. As the natural resin, for example, there may be mentioned a rosin, a dammar, a mastic, a copal, an amber, a shellac, a dragon's blood, a sandarac, a colophonium starch, a casein, a gelatin, or a natural rubber. As the synthetic resin, for example, there may be mentioned a thermosetting resin, such as a phenol resin, an epoxy resin, a melamine resin, an urea resin, an unsaturated polyester resin, an alkyd resin, a polyurethane, or a thermosetting polyimide resin; or a thermoplastic resin, such as an AS resin, an ABS resin, a polypropylene, a polyethylene, a poly(vinyl chloride), a polystyrene, an acrylic resin, a polyester resin, a poly(ethylene terephthalate), a poly(phenylene ether), a poly(butylene terephthalate), a nylon, a polyamide, a polycarbonate, a polyacetal, a poly(phenylene sulfide), a poly(ether ketone), a styrene-based resin, an acryl-based resin, a styrene-acryl-based resin, an olefin-based resin, a vinyl chloride-based resin, a polyester-based resin, a polyamide-based resin, a polyurethane-based resin, a poly(vinyl alcohol)-based resin, a vinyl ether-based resin, an N-vinyl-based resin, or a styrene-butadiene-based resin. In view of the reduction in environmental load, a natural resin is preferable. When the resin mentioned above is added to the fibroin, the tensile strength can be further improved, and in addition, an improvement in productivity and a reduction of cost can be expected.

In the fibroin Sb, a coloring agent to color the fiber structural body and/or a flame retardant which enables the fiber structural body and the like not to be easily combusted may be contained. In addition, an aggregation suppressor which prevents aggregation of the fibroin Sb may also be contained. As the aggregation suppressor, fine particles formed from an inorganic material may be mentioned, and when those particles are disposed on the surface of the fibroin Sb, a significantly excellent aggregation suppressing effect can be obtained. As a particular example of a material of the aggregation suppressor, for example, titanium oxide, aluminum oxide, zinc oxide, cerium oxide, magnesium oxide, zirconium oxide, strontium titanate, barium titanate, or calcium carbonate may be mentioned. Although being not particularly limited, the average particle diameter (number average particle diameter) of the particles of the aggregation suppressor is preferably 0.001 to 1 μm and more preferably 0.008 to 0.6 μm. When the particle diameter of primary particles of the aggregation suppressor is in the range described above, preferable coating can be performed on the surface of the fibroin Sb, and a sufficient aggregation suppressing effect can be obtained. When an amount of the aggregation suppressor to be added to the fibroin Sb is set to 0.1 to 5 percent by mass with respect to 100 parts by mass of the fibroin Sb, the effect described above can be obtained, and for example, in order to enhance the effect described above and/or to suppress the aggregation suppressor from being separated from a sheet to be manufactured, the amount of the aggregation suppressor with respect to 100 parts by mass of the fibroin Sb can be set to preferably 0.2 to 4 parts by mass and more preferably 0.5 to 3 parts by mass. As a mode of disposing the aggregation suppressor on the surface of the fibroin Sb, although coating, covering, or the like may be mentioned, the entire surface of the fibroin Sb is not always required to be covered.

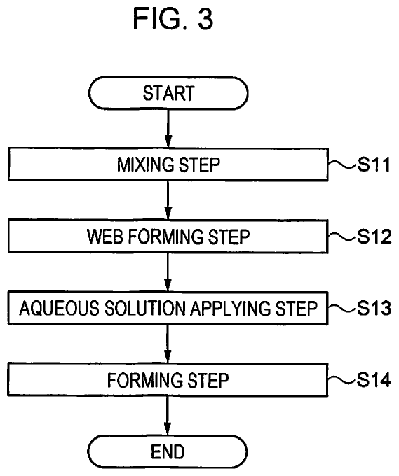

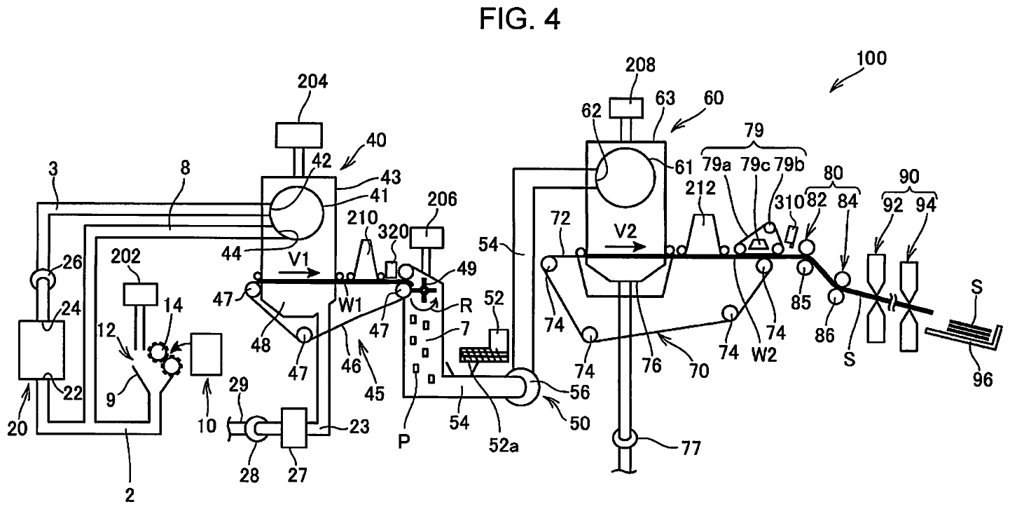

Next, a method for manufacturing the fiber structural body S will be described. FIG. 3 is a flowchart showing the method for manufacturing the fiber structural body S. FIG. 4 is a schematic view showing the structure of a manufacturing apparatus 100 which manufactures the fiber structural body S.

As shown in FIG. 3, the method for manufacturing the fiber structural body S includes a mixing step (Step S11) of mixing the fibers Se and the fibroin Sb which binds the fibers Sa to form a fiber body; a web forming step (Step S12) of depositing the fiber body in air to form a web; an aqueous solution applying step (Step S13) of applying an aqueous solution to the web; and a forming step (Step S14) of pressurizing and heating the web to which the aqueous solution is applied to form the fiber structural body S.

In the method described above, in the mixing step, when the fibers Sa are represented by A, and the fibroin Sb is represented by B, the following formulas (1) and (2) are satisfied, and in the aqueous solution applying step, when moisture contained in the fiber structural body after the aqueous solution application is represented by C, the following formula (3) is satisfied.

0.03≤volume average particle diameter of B/average width of A in short direction≤4.00 (1)

0.01≤mass of B/(mass of A+mass of B)≤0.40 (2)

0.2≤mass of C/(mass of A+mass of B)≤10.0 (3)

In this case, the average width of the fibers Sa in the short direction indicates the dimension H shown in FIG. 2, the mass of A is an absolute dry mass of A in the fiber structural body, and the mass of B is an absolute dry mass of B in the fiber structural body.

In addition, in more preferable, 0.5≤volume average particle diameter of B/average width of A in short direction≤2.00, 0.10≤mass of B/(mass of A+mass of B)≤0.20, and 0.5≤mass of C/(mass of A+mass of B)≤2.0 are satisfied.

Hereinafter, a method for manufacturing the fiber structural body S using the manufacturing apparatus 100 will be described.

The manufacturing apparatus 100 is, for example, a preferable apparatus which manufactures a new sheet-shaped fiber structural body S, that is, recycle paper, by defibrating used waste paper as a raw material into fibers by a dry method, followed by pressure application, heating, and cutting. In addition, the fiber structural body S manufactured in this embodiment is paper having an A4 size. In addition, in accordance with the application, such as office paper having various sizes or paper for name cards, by the manufacturing apparatus 100, sheet-shaped fiber structural bodies S having various thicknesses and sizes can be manufactured.

As shown in FIG. 4, the manufacturing apparatus 100 includes, for example, a supply portion 10, a coarsely pulverizing portion 12, a defibrating portion 20, a sorting portion 40, a first web forming portion 45, a rotation body 49, a mixing portion 50, a deposition portion 60, a second web forming portion 70, a transport portion 79, an aqueous solution application portion 310, a sheet forming portion 80, and a cutting portion 90.

In this embodiment, the mixing portion 50 corresponds to the mixing step (Step S11), the deposition portion 60 and the second web forming portion 70 correspond to the web forming step (Step S12), the aqueous solution application portion 310 corresponds to the aqueous solution applying step (Step S13), and the sheet forming portion 80 corresponds to the forming step (Step S14).

In order to humidify the raw material, a space in which the raw material is transferred, and the like, the manufacturing apparatus 100 further includes humidifying portions 202, 204, 206, 208, 210, and 212.

The supply portion 10 supplies the raw material to the coarsely pulverizing portion 12. The raw material to be supplied to the coarsely pulverizing portion 12 is a material containing cellulose-based fibers of waste paper and/or pulp. In this embodiment, the structure in which waste paper is used as the raw material will be described by way of example. The supply portion 10 includes, for example, a stacker in which waste paper is stacked and stored and an automatic charge device which feeds the waste paper from the stacker to the coarsely pulverizing portion 12.

The coarsely pulverizing portion 12 cuts the raw material supplied by the supply portion 10 using coarsely pulverizing blades 14 into coarsely pulverized pieces. The coarsely pulverizing blade 14 cuts the raw material in air, such as in the air. The coarsely pulverizing portion 12 includes, for example, a pair of the coarsely pulverizing blades 14 which nip and cut the raw material and a drive portion which rotates the coarsely pulverizing blades 14 and can be formed to have a structure similar to that of a so-called shredder.

The coarsely pulverizing portion 12 includes a shoot 9 receiving the coarsely pulverized pieces which fall down after being cut by the coarsely pulverizing blades 14. A tube 2 which communicates with the defibrating portion 20 is coupled to the shoot 9 to form a transport path through which the coarsely pulverized pieces are transported to the defibrating portion 20.

The defibrating portion 20 defibrates the coarsely pulverized pieces cut in the coarsely pulverizing portion 12. In more particular, in the defibrating portion 20, the raw material cut by the coarsely pulverizing portion 12 is processed by a defibrating treatment to produce a defibrated material. In this case, the “defibrate” indicates that the raw material formed of fibers bound to each other is disentangled into separately independent fibers. The defibrating portion 20 has a function to separate substances, such as resin particles, an ink, a toner, and a blurring inhibitor, each of which is adhered to the raw material, from the fibers.

The defibrating portion 20 performs dry defibration. In this case, a treatment, such as defibration, which is performed not in a liquid but in a gas, such as in the air, is called a dry type. The defibrating portion 20 is formed using an impellor mill or the like. The defibrated material is fed to a tube 3 from a discharge port 24 and then transported to the sorting portion 40 through a defibrating blower 26.

The sorting portion 40 includes an inlet port 42 into which the defibrated material defibrated in the defibrating portion 20 flows together with an air stream through the tube 3. The sorting portion 40 sorts the defibrated material introduced into the inlet port 42 by the length of the fibers. In particular, the sorting portion 40 sorts the defibrated material defibrated in the defibrating portion 20 into a defibrated material having a predetermined size or less as a first sorted material and a defibrated material larger than the first sorted material as a second sorted material. The first sorted material includes the fibers Sa, particles, and the like, and the second sorted material includes, for example, large fibers, non-defibrated pieces, coarsely pulverized pieces which are not sufficiently defibrated, and damas which are formed since defibrated fibers are aggregated or entangled with each other.

The sorting portion 40 includes, for example, a drum portion 41 and a housing portion 43 receiving the drum portion 41.

The drum portion 41 is a cylindrical sieve which is rotatably driven by a motor. The drum portion 41 has a net and functions as a sieve. By the meshes of this net, the drum portion 41 sorts the first sorted material smaller than sieve openings of the net and the second sorted material larger than the sieve openings of the net.

The defibrated material introduced into the inlet port 42 is fed together with the air stream to the inside of the drum portion 41, and by the rotation of the drum portion 41, the first sorted material is allowed to fall down through the meshes of the net of the drum portion 41. The second sorted material which is not allowed to pass through the meshes of the net of the drum portion 41 is guided to a discharge port 44 by the air stream flowing into the drum portion 41 from the inlet port 42 and is then fed to a tube 8. The second sorted material which flows through the tube 8 is allowed to flow together with the coarsely pulverized pieces cut in the coarsely pulverizing portion 12 in the tube 2 and is guided to an inlet port 22 of the defibrating portion 20.

In addition, the first sorted material sorted by the drum portion 41 is dispersed in air through the meshes of the net of the drum portion 41 and is then allowed to fall down to a mesh belt 46 of the first web forming portion 45 located under the drum portion 41.

The first web forming portion 45 includes the mesh belt 46, rollers 47, and a suction portion 48. The mesh belt 46 is an endless-shaped belt, is suspended by the three rollers 47, and by the movement of the rollers 47, is transported in a direction shown by an arrow in the drawing. The surface of the mesh belt 46 is formed of a net in which openings having a predetermined size are arranged. Of the first sorted material which is allowed to fall down from the sorting portion 40, fine particles passing through the meshes of the net fall down to a lower side of the mesh belt 46, and fibers Sa having a size which are not allowed to pass through the meshes of the net are deposited on the mesh belt 46 and are transported therewith in the arrow direction. In this step, the dimension H of the average width in the short direction of the fibers Sa deposited on the mesh belt 46 is 1 to 100 μm.

The fine particles falling down through the mesh belt 46 are relatively small particles and/or particles having a low density of the defibrated materials.

The suction portion 48 sucks air under the mesh belt 46. The suction portion 48 is coupled to a dust collection portion 27 through a tube 23. A collection blower 28 is provided at downstream of the dust collection portion 27 and functions as a dust suction portion which sucks air from the dust collection portion 27. In addition, air discharged from the collection blower 28 is discharged outside of the manufacturing apparatus 100 through a tube 29.

In a transport path of the mesh belt 46, at downstream of the sorting portion 40, air containing mist is supplied by the humidifying portion 210. The mist which is fine particles of water generated by the humidifying portion 210 falls down to a first web W1 and supplies moisture thereto. Accordingly, the moisture amount contained in the first web W1 is adjusted, and hence, for example, the adsorption of the fibers Sa to the mesh belt 46 caused by static electricity can be suppressed.

The manufacturing apparatus 100 includes the rotation body 49 which divides the first web W1 deposited on the mesh belt 46. The first web W1 is peeled away from the mesh belt 46 at a position at which the mesh belt 46 is folded by the roller 47 and is then divided by the rotation body 49.

Since the first web W1 is a soft material having a web shape formed by deposition of the fibers Sa, and the rotation body 49 disentangles the fibers Sa of the first web W1, the first web W1 is processed so as to be easily mixed with the fibroin Sb in the mixing portion 50 which will be described later.

Although the structure of the rotation body 49 is arbitrarily formed, in the example shown in the drawing, the rotation body 49 has a rotating blade shape having rotatable plate-shaped blades. The rotation body 49 is disposed at a position at which the first web W1 peeled away from the mesh belt 46 is brought into contact with the blade. By the rotation of the rotation body 49, such as the rotation in a direction indicated by an arrow R in the drawing, the first web W1 peeled away from and transported by the mesh belt 46 collides with the blade and is divided thereby, so that small parts P are produced.

In addition, the rotation body 49 is preferably placed at a position at which the blade of the rotation body 49 does not collide with the mesh belt 46.

The small parts P divided by the rotation body 49 fall down in a tube 7 and are then transported to the mixing portion 50 by an air stream flowing inside the tube 7.

The mixing portion 50 includes a binding material supply portion 52 which supplies the fibroin Sb, a tube 54 which communicates with the tube 7 and through which an air stream containing the small parts P flows, and a mixing blower 56.

The small parts P are formed of the fibers Sa obtained by removing unnecessary materials from the first sorted material passing through the sorting portion 40 as described above. The mixing portion 50 mixes the fibroin Sb and the fibers Sa which form the small parts P.

In the mixing portion 50, an air stream is generated by the mixing blower 56, and the small parts P and the fibroin Sb are transported in the tube 54 while being mixed together. In addition, the small parts P are disentangled in a process in which the small parts P flow inside the tube 7 and the tube 54, so that finer fibrous parts are formed.

The binding material supply portion 52 is coupled to a cartridge (not shown) in which the fibroin Sb is stored, and the fibroin Sb in the cartridge is supplied to the tube 54. The cartridge may have a structure detachable to the binding material supply portion 52. The binding material supply portion 52 temporarily stores the fibroin Sb. The binding material supply portion 52 includes a discharge portion 52a which supplies the stored fibroin Sb to the tube 54.

The fibroin Sb is at least one selected from a material produced by an arthropod or its larva, a material derived therefrom, and an artificially produced material. That is, the fibroin Sb is a naturally-derived material. In addition, besides the fibroin Sb, as the binding material which binds the fibers to each other, a natural resin and/or a synthetic resin may be further contained.

In the binding material supply portion 52, the fibroin Sb is supplied so as to satisfy the following formula.

0.03≤volume average particle diameter of fibroin Sb/average width of fibers Sa in short direction≤4.00 is satisfied, and 0.5≤volume average particle diameter of fibroin Sb/average width of fibers Sa in short direction≤2.00 is further satisfied.

In addition, 0.01≤dry mass of fibroin Sb with respect to total mass of fiber structural body/(dry mass of fibers Sa with respect to total mass of fiber structural body+dry mass of fibroin Sb with respect to total mass of fiber structural body)≤0.40 is satisfied. Furthermore, 0.10≤dry mass of B with respect to total mass of fiber structural body/(dry mass of A with respect to total mass of fiber structural body+dry mass of B with respect to total mass of fiber structural body)≤0.20 is satisfied.

By the air stream generated by the mixing blower 56, the small parts P falling down in the tube 7 and the fibroin Sb supplied by the binding material supply portion 52 are sucked in the tube 54 and are allowed to pass inside the mixing blower 56. By the air stream generated by the mixing blower 56 and the function of a rotation portion, such as a blade, of the mixing blower 56, the fibers Sa forming the small parts P and the fibroin Sb are mixed together, so that the fiber body is formed. This fiber body, that is, a fiber body in which the first sorted material and the fibroin Sb are mixed together, is transported to the deposition portion 60 through the tube 54.

In addition, a mechanism in which the first sorted material and the fibroin Sb are mixed together is not particularly limited and may be stirring which is performed by a blade rotatable at a high speed. In addition, rotation of a container, such as a V type mixer, may also be used, and those mechanisms each may be disposed at upstream or downstream of the mixing blower 56.

The deposition portion 60 introduces the fiber body passing through the mixing portion 50 through an inlet port 62 and disentangles the fiber body thus entangled, so that the fiber body is allowed to fall down while being dispersed in air. Accordingly, the deposition portion 60 can uniformly deposit the fiber body in the second web forming portion 70.

The deposition portion 60 includes a drum portion 61 and a housing portion 63 receiving the drum portion 61. The drum portion 61 is a cylindrical sieve rotatably driven by a motor. The drum portion 61 has a net and functions as a sieve. By the meshes of this net, the drum portion 61 allows the fibers Sa and particles, each of which is smaller than the mesh opening of this net, to pass through and fall down from the drum portion 61. For example, the structure of the drum portion 61 is the same as that of the drum portion 41.

In addition, the “sieve” of the drum portion 61 may not have a function to sort a specific object. That is, the “sieve” to be used as the drum portion 61 indicates a member provided with a net, and the drum portion 61 may allow all of the fiber body introduced thereinto to fall down.

Under the drum portion 61, the second web forming portion 70 is disposed. The second web forming portion 70 deposits a material passing through the deposition portion 60 to form a second web W2 as the web. The second web forming portion 70 includes, for example, a mesh belt 72, rollers 74, and a suction mechanism 76.

The mesh belt 72 is an endless-shaped belt, is suspended by the rollers 74, and by the movement of the rollers 74, is transported in a direction shown by an arrow in the drawing. The mesh belt 72 is formed, for example, of a metal, a resin, a cloth, or a non-woven cloth. The surface of the mesh belt 72 is formed of a net in which openings having a predetermined size are arranged. Of the fibers Sa and particles which are allowed to fall down from the drum portion 61, fine particles having a size which are allowed to pass through the meshes of the net fall down to a lower side of the mesh belt 72, and fibers having a size which are not allowed to fall down through the meshes of the net are deposited on the mesh belt 72 and are transported therewith in the arrow direction. The mesh belt 72 is transferred at a predetermined velocity V2 during a normal operation for manufacturing of the fiber structural body S. The “the normal operation” indicates the operation described above.

The meshes of the net of the mesh belt 72 are fine and may be set so that most of the fibers Sa and particles falling down from the drum portion 61 are not allowed to pass therethrough.

The suction mechanism 76 is provided at a lower side of the mesh belt 72. The suction mechanism 76 includes a suction blower 77, and by a suction force of the suction blower 77, an air stream toward a lower side can be generated in the suction mechanism 76.

By the suction mechanism 76, the fiber body dispersed in air by the deposition portion 60 is sucked on the mesh belt 72. Accordingly, the formation of the second web W2 on the mesh belt 72 is promoted, and hence, a discharge rate from the deposition portion 60 can be increased. Furthermore, by the suction mechanism 76, a downflow can be formed in a falling path of the fiber body, and hence, the fibers Sa and the fibroin Sb can be prevented from being entangled with each other during the falling.

The suction blower 77 may discharge air sucked from the suction mechanism 76 outside of the manufacturing apparatus 100 through a collection filter (not shown). Alternatively, air sucked by the suction blower 77 may be fed to the dust collection portion 27 so that unnecessary materials contained in the air sucked by the suction mechanism 76 may be collected.

To a space including the drum portion 61, humidified air is supplied by the humidifying portion 208. By this humidified air, the inside of the deposition portion 60 can be humidified, and the adhesion of the fibers Sa and the fibroin Sb to the housing portion 63 caused by static electricity is suppressed, so that the fibers Sa and the fibroin Sb are allowed to rapidly fall down on the mesh belt 72, and the second web W2 can be formed to have a preferable shape.

As described above, through the deposition portion 60 and the second web forming portion 70, the second web W2 can be formed so as to be softly expanded with a large amount of air incorporated therein. The second web W2 deposited on the mesh belt 72 is transported to the sheet forming portion 80.

In a transport path of the mesh belt 72, at downstream of the deposition portion 60, by the humidifying portion 212, air containing mist is supplied. Accordingly, the mist generated by the humidifying portion 212 is supplied to the second web W2, so that the content of moisture contained in the second web W2 is adjusted. Accordingly, for example, the adsorption of the fibers Sa to the mesh belt 72 caused by static electricity can be suppressed.

The manufacturing apparatus 100 includes the transport portion 79 which transports the second web W2 on the mesh belt 72 to the sheet forming portion 80. The transport portion 79 includes, for example, a mesh belt 79a, rollers 79b, and a suction mechanism 79c.

The suction mechanism 79c includes a blower not shown, and by a suction force of the blower, an upward air stream is generated to the mesh belt 79a. This air stream sucks the second web W2, and the second web W2 is separated from the mesh belt 72 and then adsorbed to the mesh belt 79a. The mesh belt 79a is transferred by the rotations of the rollers 79b, so that the second web W2 is transported to the sheet forming portion 80. The transfer rate of the mesh belt 72 is the same, for example, as the transfer rate of the mesh belt 79a.

As described above, the transport portion 79 peels away the second web W2 formed on the mesh belt 72 therefrom and then transports the second web W2 thus peeled away.

At downstream of the transport portion 79, the aqueous solution application portion 310 is disposed. The aqueous solution application portion 310 applies an aqueous solution to the second web W2. The aqueous solution may contain, besides water, one of alcohols including methyl alcohol, ethyl alcohol, isopropyl alcohol, butanol, and hexanediol and glycols including glycerin, ethylene glycol, propylene glycol, diethylene glycol, triethylene glycol, a polyethylene glycol, butylene glycol, and thiodiglycol.

In the present disclosure, as the water contained in the aqueous solution, purified water, such as ion-exchanged water, ultrafiltration water, reverse osmosis water, or distilled water, or ultra purified water is preferably used. In particular, water sterilized by UV irradiation or addition of hydrogen peroxide is preferable since the generation of fungi and/or bacterial can be suppressed for a long time.

The aqueous solution application portion 310 applies the aqueous solution so as to satisfy the following formula.

First, 0.2≤moisture amount contained in fiber structural body after aqueous solution application/(dry mass of fiber Sa with respect to total mass of fiber structural body+dry mass of fibroin Sb with respect to total mass of fiber structural body≤10.0 is satisfied. Furthermore, 0.5≤moisture amount contained in fiber structural body after aqueous solution application/(dry mass of fiber Sa with respect to total mass of fiber structural body+dry mass of fibroin Sb with respect to total mass of fiber structural body≤2.0 is satisfied.

When the aqueous solution is applied to the second web W2, formation of hydrogen bonds between the fibers Sa is promoted, and hence, a binding strength between the fibers Sa can be increased.

The aqueous solution application portion 310 of this embodiment applies the aqueous solution to the second web W2. As the application method, a known method may be used, and for example, a roll coater, a die coater, a spray, or an ink jet may be mentioned. Furthermore, in order to suppress damage on the second web W2, the aqueous solution is preferably applied in a contactless manner. The aqueous solution application portion 310 has a structure mounting an ink jet head. This ink jet head includes a piezoelectric element as a drive portion, and by displacement of the piezoelectric element, the aqueous solution can be ejected in the form of liquid droplets. In addition, the aqueous solution application portion 310 may be a portion having a spray structure, an atomizer structure, or the like. Accordingly, the damage on the second web W2 can be suppressed.

The sheet forming portion 80 forms the fiber structural body S from the second web W2 to which the aqueous solution is applied. In more particular, the sheet forming portion 80 forms the fiber structural body S by pressurizing and heating the second web W2 which is deposited on the mesh belt 72 and is then transported by the transport portion 79. In the sheet forming portion 80, since the second web W2 is heated, the fibers Sa are bound to each other with the fibroin Sb interposed therebetween.

The sheet forming portion 80 includes a pressure application portion 82 which pressurizes the second web W2 and a heating portion 84 which heats the second web W2 pressurized by the pressure application portion 82.

The pressure application portion 82 is formed of a pair of calendar rollers 85 which nip the second web W2 at a predetermined nip pressure for pressure application. An application pressure by the pressure application portion 82 is 10 to 80 MPa and preferably 30 to 50 MPa. Since the second web W2 is pressurized, the thickness thereof is decreased, and hence, the density of the second web 12 is increased. One of the pair of calendar rollers 85 is a drive roller driven by a motor not shown in the drawing, and the other roller is a driven roller. The calendar rollers 85 are rotated by a driving force of the motor, and the second web W2, the density of which is increased by the pressure application, is transported toward the heating portion 84.

The heating portion 84 is appropriately formed, for example, using at least one of a heating roller machine, a heat press forming machine, a hot plate, a hot-wind blower, an infrared heater, a flash fixing device, a steam heating cylinder, a heated hot wind dryer, a gas heater dryer, an electric heater dryer, and an infrared heater dryer. In the example shown in the drawing, the heating portion 84 includes a pair of heating rollers 86. The heating rollers 86 are heated to a predetermined temperature by a heater disposed inside or outside. The heating rollers 86 nip the second web W2 pressurized by the calendar rollers 85 for heating, so that the fiber structural body S is formed. A heating temperature at the heating portion 84 is 80° C. to 230° C. Accordingly, the fibroin Sb between the fibers Sa is melted, and the binding strength between the fibers Sa can be increased. In addition, at the heating rollers 86, the pressure application is also performed at a pressure of 10 to 80 MPa and preferably at 30 to 50 MPa.

One of the pair of heating rollers 86 is a drive roller driven by a motor not shown in the drawing, and the other roller is a driven roller. The heating rollers 86 are rotated by a driving force of the motor, so that the fiber structural body S thus heated is transported toward the cutting portion 90.

As described above, the second web W2 formed in the deposition portion 60 is heated and pressurized in the sheet forming portion 80, so that the sheet-shaped fiber structural body S is formed.

In addition, the number of the calendar rollers 85 of the pressure application portion 82 and the number of the heating rollers 86 of the heating portion 84 are not particularly limited.

The cutting portion 90 cuts the fiber structural body S formed in the sheet forming portion 80. In the example shown in the drawing, the cutting portion 90 includes a first cutting portion 92 which cuts the fiber structural body S in a direction intersecting a transport direction of the fiber structural body S and a second cutting portion 94 which cuts the fiber structural body S in a direction parallel to the transport direction. The second cutting portion 94 cuts, for example, the fiber structural body S which passes through the first cutting portion 92.

As described above, a single fiber structural body S having a predetermined size is formed. The single fiber structural body S thus cut is discharged to a discharge portion 96. The discharge portion 96 includes a tray or a stacker on each of which the fiber structural body S having a predetermined size is placed.

In addition, before the aqueous solution applying step (Step S13) in which the aqueous solution is applied to the second web W2 by the aqueous solution application portion 310, a hydrophilic treatment step of performing a hydrophilic treatment on the surfaces of the fibers Sa may be performed. In more preferable, before the mixing step (Step S11), the hydrophilic treatment step may be performed.

In this embodiment, a plasma treatment device 320 is disposed as a hydrophilic treatment device between the sorting portion 40 and the binding material supply portion 52. The plasma treatment device 320 generates and applies plasma beams to the first web W1 deposited on the mesh belt 46. Accordingly, generated active oxygen collides on the surfaces of the fibers Sa forming the first web W1, cuts molecular chains of surface layers thereof, and produces new functional groups (OH, CHO, COOH, and/or the like) by a reaction with the molecules thus cut, so that the hydrophilic treatment is performed. Accordingly, the binding strength between the fibers Sa can be increased.

In addition, instead of the plasma treatment device 320, for example, an UV ozone device which generates UV ozone or a corona discharge treatment device may be used. In addition, the plasma treatment device 320 may be disposed at the coarsely pulverizing portion 12 or between the deposition portion 60 and the aqueous solution application portion 310.

In addition, although the structure in which the fiber structural body S is manufactured from the raw material which is coarsely pulverized at the coarsely pulverizing portion 12 is described, for example, the structure in which the fiber structural body S is manufactured using the fibers Sa as the raw material may also be used.

For example, the structure in which fibers equivalent to the defibrated material obtained by the defibration treatment in the defibrating portion 20 is charged as the raw material to the drum portion 41 may also be used. In addition, the structure in which the fibers Sa equivalent to the first sorted material separated from the defibrated material is charged as the raw material to the tube 54 may also be used. In this case, when the fibers Sa obtained by processing old paper, pulp, or the like are supplied to the manufacturing apparatus 100, the fiber structural body S can be manufactured.

As described above, since the fibers Sa are bound to each other with the naturally-derived fibroin Sb, the environmental load can be reduced. In addition, since the conditions of the above formulas are satisfied, a fiber structural body S which secures the tensile strength and the folding resistance can be manufactured.

### 2. Embodiment 2

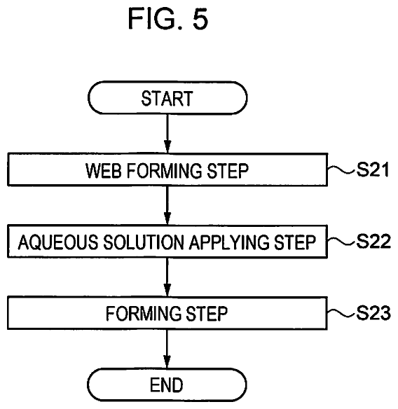

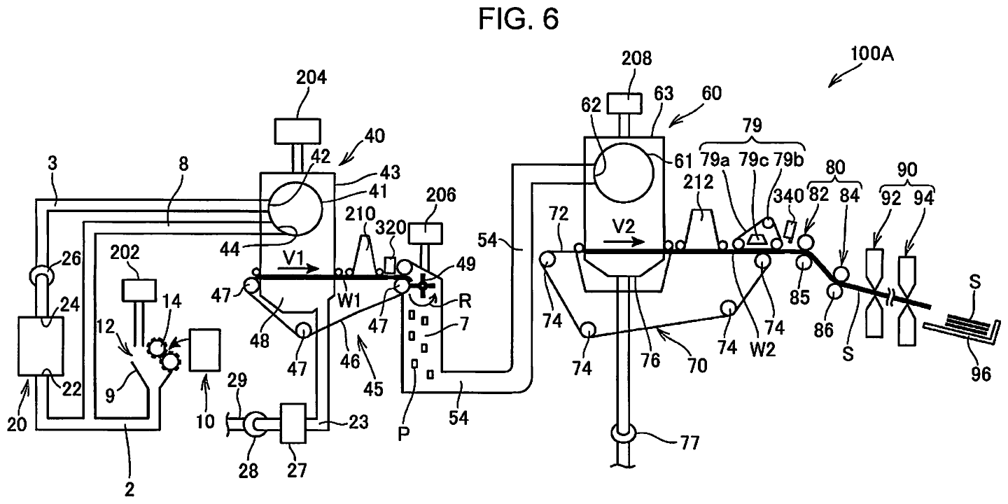

FIG. 5 is a flowchart showing a method for manufacturing a fiber structural body S according to this embodiment. FIG. 6 is a schematic view showing the structure of a manufacturing apparatus 100A forming the fiber structural body S according to this embodiment. In addition, the same constituent elements as those of Embodiment 1 are designated by the same reference numerals, and duplicated description thereof will be omitted. In addition, since the structure of the fiber structural body S manufactured by the manufacturing apparatus 100A is the same as that of Embodiment 1, description thereof will be omitted.

As shown in FIG. 5, the method for manufacturing the fiber structural body S includes a web forming step (Step S21) of depositing a fiber body containing fibers Sa in air to form a web, an aqueous solution applying step (Step S22) of applying an aqueous solution containing a fibroin Sb to the web, and a forming step (Step S23) of pressuring and heating the web to which the aqueous solution is applied to form the fiber structural body S.

In this embodiment, in the aqueous solution applying step, when the fibers Sa are represented by A, the fibroin Sb is represented by B, and moisture contained in the fiber structural body after the aqueous solution application is represented by C, the following formulas (1) and (2) are satisfied.

0.01≤dry mass of B with respect to total mass of fiber structural body/(dry mass of A with respect to total mass of fiber structural body+dry mass of B with respect to total mass of fiber structural body)≤0.40 (1)

0.2≤mass of C/(dry mass of A with respect to total mass of fiber structural body+dry mass of B with respect to total mass of fiber structural body≤10.0 (2)

In addition, the following formulas are more preferably satisfied.

0.10≤dry mass of B with respect to total mass of fiber structural body/(dry mass of A with respect to total mass of fiber structural body+dry mass of B with respect to total mass of fiber structural body)≤0.20

0.5≤mass of C/(dry mass of A with respect to total mass of fiber structural body+dry mass of B with respect to total mass of fiber structural body≤2.0

Hereinafter, the method for manufacturing the fiber structural body S using the manufacturing apparatus 100A will be described.

As shown in FIG. 6, the manufacturing apparatus 100A includes a supply portion 10, a coarsely pulverizing portion 12, a defibrating portion 20, a sorting portion 40, a first web forming portion 45, a rotation body 49, a deposition portion 60, a second web forming portion 70, a transport portion 79, an aqueous solution application portion 340, a sheet forming portion 80, and a cutting portion 90. In addition, a plasma treatment device 320 which hydrophilizes the surfaces of the fibers Sa is also included. That is, in this embodiment, the mixing portion (corresponding to the mixing step) mixing the fibers Sa and the fibroin Sb is omitted, and the point described above is different from the structure of Embodiment 1.

In this embodiment, the deposition portion 60 and the second web forming portion 70 correspond to the web forming step (Step S21), the aqueous solution application portion 340 corresponds to the aqueous solution applying step (Step S22), and the sheet forming portion 80 corresponds to the forming step (Step S23).

In the manufacturing apparatus 100A, since the structures and the process conditions of the supply portion 10, the coarsely pulverizing portion 12, the defibrating portion 20, the sorting portion 40, the first web forming portion 45, the rotation body 49, the transport portion 79, the sheet forming portion 80, and the cutting portion 90 are similar to those described in Embodiment 1, description thereof will be omitted. Furthermore, since the structure of the plasma treatment device 320 (corresponding to the hydrophilic treatment step) is also similar to that of Embodiment 1, description thereof will be omitted.

In the deposition portion 60, the fiber body containing the fibers Sa transported from upstream is allowed to fall down while being dispersed in air. Accordingly, the deposition portion 60 can uniformly deposit the fiber body on the second web forming portion 70. The second web forming portion 70 is disposed under a drum portion 61 of the deposition portion 60. The second web forming portion 70 deposits a material passing through the deposition portion 60 and forms a second web W2 as the web. In addition, since the detailed structures of the deposition portion 60 and the second web forming portion 70 are similar to those of the structure of Embodiment 1, description thereof will be omitted.

At downstream of the transport portion 79, the aqueous solution application portion 340 is disposed. The aqueous solution application portion 340 applies an aqueous solution containing the fibroin Sb to he second web W2. The aqueous solution contains at least one of alcohols including methyl alcohol, ethyl alcohol, isopropyl alcohol, butanol, and hexanediol and glycols including glycerin, ethylene glycol, propylene glycol, diethylene glycol, triethylene glycol, a polyethylene glycol, butylene glycol, and thiodiglycol. For example, when an alcohol is contained, since curing of the fibroin is promoted, the strength can be improved, and in addition, when a glycol is contained, the flexibility can also be improved.

In the aqueous solution application portion 310, the aqueous solution is applied so as to satisfy the following formulas.

First, 0.2≤moisture amount contained in fiber structural body after aqueous solution application/(dry mass of fiber Sa with respect to total mass of fiber structural body+dry mass of fibroin Sb with respect to total mass of fiber structural body≤10.0 is satisfied. Furthermore, 0.5≤moisture amount contained in fiber structural body after aqueous solution application/(dry mass of fiber Sa with respect to total mass of fiber structural body+dry mass of fibroin Sb with respect to total mass of fiber structural body≤2.0 is satisfied.

In addition, 0.01≤dry mass of fibroin Sb with respect to total mass of fiber structural body/(dry mass of fibers Sa with respect to total mass of fiber structural body+dry mass of fibroin Sb with respect to total mass of fiber structural body≤0.40 is satisfied. Furthermore, 0.10≤dry mass of fibroin Sb with respect to total mass of fiber structural body/(dry mass of fibers Sa with respect to total mass of fiber structural body+dry mass of fibroin Sb with respect to total mass of fiber structural body≤0.20 is satisfied. Since the aqueous solution containing the fibroin Sb is applied to the second web W2, the fibroin Sb can be easily added to the fibers Sa, and in addition, since the formation of hydrogen bonds between the fibers Sa is promoted, the binding strength between the fibers Sa can be increased.

The aqueous solution application portion 340 of this embodiment applies the aqueous solution containing the fibroin Sb to the second web W2. As an application method, a known method may be used, and for example, a roll coater, a die coater, a spray, or an ink jet may be mentioned. Furthermore, in order to suppress damage on the second web W2, the aqueous solution containing the fibroin Sb is preferably applied in a contactless manner. For the aqueous solution application portion 340, for example, a structure which mounts an ink jet head capable of ejecting an aqueous solution in the form of liquid droplets, a spray structure, or an atomizer structure may be used. Accordingly, the damage on the second web W2 can be suppressed.

Hereinafter, the fiber structural body S is formed through the sheet forming portion 80 and the cutting portion 90.

According to this embodiment, besides the effect of Embodiment 1, in the manufacturing of the fiber structural body S, since the mixing portion (corresponding to the mixing step) mixing the fibers Sa and the fibroin Sb is omitted, the method for manufacturing the fiber structural body S and the structure of the manufacturing apparatus 100A can be simplified.

### 3. Embodiment 3

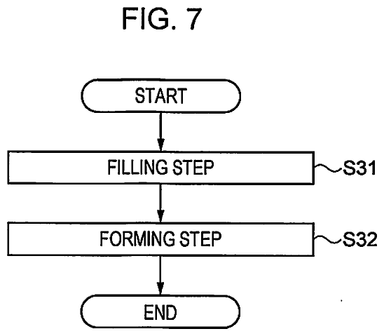

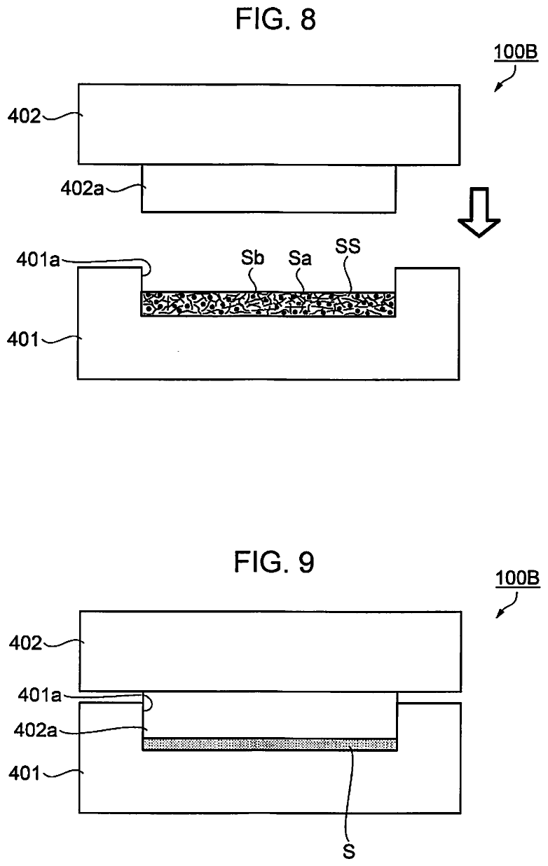

FIG. 7 is a flowchart showing a method for manufacturing a fiber structural body S according to this embodiment. FIGS. 8 and 9 are each a schematic view showing the method for manufacturing the fiber structural body S according to this embodiment and a manufacturing apparatus 100B therefor. In addition, since the structure of the fiber structural body S manufactured by the manufacturing apparatus 100B is similar to that of Embodiment 1, description thereof will be omitted.

As shown in FIG. 7, the method for manufacturing the fiber structural body S includes a filling step (Step S31) and a forming step (Step S32).

As shown in FIG. 8, the manufacturing apparatus 100B of this embodiment is a pressure heating apparatus including as a molding die, a lower mold portion 401 and an upper mold portion 402. The lower mold portion 401 has a concave portion 401a. The upper mold portion 402 has a head portion 402a to be fitted to the concave portion 401a.

Hereinafter, the method for manufacturing the fiber structural body S using the manufacturing apparatus 100B will be described.

In the filling step of Step S31, a mixture SS in which fibers Sa, a fibroin Sb which binds the fibers Sa, and an aqueous solution are mixed together is filled in the concave portion 401a of the lower mold portion 401.

As the fibers Sa, for example, there may be used fibers equivalent to the first sorted material which are obtained by separating from a defibrated material formed by performing a defibration treatment on a material containing cellulose fibers of waste paper and/or pulp, for example, in the defibrating portion 20 shown in FIG. 4. The structure of the fibroin Sb is similar to that of Embodiment 1.

The aqueous solution may contain, besides water, one of alcohols including methyl alcohol, ethyl alcohol, isopropyl alcohol, butanol, and hexanediol and glycols including glycerin, ethylene glycol, propylene glycol, diethylene glycol, triethylene glycol, a polyethylene glycol, butylene glycol, and thiodiglycol.

In this embodiment, in the filling step, when the fibers Sa are represented by A, the fibroin Sb is represented by B, and moisture contained in the fiber structural body after the aqueous solution application is represented by C, the following formulas (1), (2), and (3) are satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

0.2≤mass of C/(dry mass of A with respect to total mass of fiber structural body+dry mass of B with respect to total mass of fiber structural body≤10.0 (3)

The average width of the fibers Sa in the short direction indicates the dimension H shown in FIG. 2.

In addition, 0.5≤volume average particle diameter of B/average width of A in short direction≤2.00, 0.10≤dry mass of B with respect to total mass of fiber structural body/(dry mass of A with respect to total mass of fiber structural body+dry mass of B with respect to total mass of fiber structural body)≤0.20, and 0.5≤mass of C/(dry mass of A with respect to total mass of fiber structural body+dry mass of B with respect to total mass of fiber structural body≤2.0 are more preferably satisfied.

In the filling step, the lower mold portion 401 and the upper mold portion 402 are heated. A heating temperature is 80° C. to 230° C. In addition, in a heating treatment, before the mixture SS is filled in the concave portion 401a, pre-heating may be performed.

Subsequently, in the forming step of Step S32, the mixture SS filled in the concave portion 401a is pressurized and heated to form the fiber structural body S. In particular, the upper mold portion 402 is allowed to descend to the lower mold portion 401, and the mixture SS filled in the concave portion 401a is pressurized by the head portion 402a. An application pressure is 10 to 80 MPa and preferably 30 to 50 MPa. Accordingly, the fiber structural body S is formed to have a sheet shape.

According to this embodiment, besides the effect of Embodiment 1, in the manufacturing of the fiber structural body S, the manufacturing method of the fiber structural body S and the structure of the manufacturing apparatus 100B can be simplified.

### 4. Examples

Next, Examples of the present disclosure will be described.

### 4-1. Examples 1 to 7

A fiber structural body S was manufactured using the manufacturing apparatus 100 shown in FIG. 4.

In particular, after a fiber body was formed by mixing fibers Sa and a fibroin Sb, the fiber body thus formed was deposited in air to form a second web W2. Subsequently, water was applied to the second web W2 by an atomizer.

In this case, when the fibers Sa are represented by A, the fibroin Sb is represented by B, and moisture contained in the fiber structural body after the water application is represented by C, the volume average particle diameter of B/the average width of A in the short direction (dimensional ratio: B/A), the dry mass of B with respect to the total mass of the fiber structural body/(the dry mass of A with respect to the total mass of the fiber structural body+the dry mass of B with respect to the total mass of the fiber structural body) (mass ratio: B/(A+B)), the mass of C/(the dry mass of A with respect to the total mass of the fiber structural body+the dry mass of B with respect to the total mass of the fiber structural body) (mass ratio: C/(A+B)) are as shown in Table 1.

Subsequently, the second web W2 to which water was applied was pressurized and heated. In particular, after being heated and pressurized at 80° C. and 10 MPa for 5 minutes, the second web W2 was further heated and pressurized at 130° C. and 30 MPa for 5 minutes. Accordingly, the fiber structural body S was formed.

In this case, the fibers Sa were cellulose fibers, and as the fibroin Sb, a nano-fibroin powder (manufactured by Matsuda silk farm corporation. inc.) was used.

### 4-2. Comparative Examples 1 to 7

Fiber structural bodies S were each manufactured by a method similar to that of the above Example as shown in Table 1.

In this case, from Comparative Examples 1 to 4, as was the case of the above Examples, a fibroin (nano-fibroin powder, manufactured by Matsuda silk farm corporation. inc.) was used as the binding material.

In Comparative Example 5, as the binding material, a starch (white corn starch: manufactured by Japan Corn Starch Co., Ltd.) was used.

In Comparative Example 6, as the binding material, a gelatin (gelatin: Wako 1st Grade, manufactured by FUJIFILM Wako Pure Chemical Corporation) was used.

In Comparative Example 7, as the binding material, a casein (casein from Milk, manufactured by Hayashi Pure Chemical Ind., Ltd.) was used.

The fibroin, the starch, the gelatin, and the casein described above were each pulverizede into a powder by freeze pulverization using a freeze pulverizer CryoMill manufactured by RETSCH.

### 4-3. Examples 8 to 15 and Comparative Examples 8 to 11

As shown in Table 2, by the use of the manufacturing apparatus 100 shown in FIG. 4, fiber structural bodies S were manufactured in a manner similar to that described above.

In addition, from Examples 8 to 11 and Comparative Examples 8 and 9, as the pressurizing and heating conditions of the second web W2, after being heated and pressurized at 80° C. and 10 MPa for 5 minutes, the second web W2 was further heated and pressurized at 105° C. and 30 MPa for 5 minutes.

In addition, from Examples 12 to 15 and Comparative Examples 10 and 11, as the pressurizing and heating conditions of the second web W2, after being heated and pressurized at 80° C. and 10 MPa for 5 minutes, the second web W2 was further heated and pressurized at 130° C. and 30 MPa for 5 minutes.

### 4-4. Evaluation

Hereinafter, based on the results of a tensile strength test, a folding resistance test, and a drying property test, evaluations were performed.

### 4-4-1. Tensile Strength Test

In accordance with JIS P 8113: 2006, the tensile strength test was performed.

In the tensile strength test, a tensile tester ASG-X500N (manufactured by Shimadzu Corporation) was used.

### 4-4-1-1. Evaluation Criteria

A: specific tensile strength of 30 N·m/g or more
B: specific tensile strength of 10 to less than 30 N·m/g
C: specific tensile strength of less than 10 N·m/g

### 4-4-2. Folding Resistance Test

In accordance with JIS P 8115, the folding resistance test was performed.

For the folding resistance test, an ultra light load folding endurance tester No. 2015-UL (manufactured by KUMAGAI RIKI KOGYO Co., Ltd.) was used.

### 4-4-2-1. Evaluation Criteria

A: folding number: 100 or more
B: folding number: 10 to less than 100
C: folding number: less than 10

### 4-4-3. Drying Property Test

By the use of a heating dry type moisture meter MX-50 (manufactured by A&D Company, Ltd.), a moisture content of the fiber structural body S was measured. In the drying property test, a heating temperature of the fiber structural body S was 120° C.

The moisture content was obtained by the following formula.

Moisture content=(W−D)/W×100(%)

In the above formula, W and D indicate the mass of the fiber structural body S before drying and the mass of the fiber structural body S after drying, respectively.

### 4-4-3-1. Evaluation Criteria

A: moisture content of less than 10%
B: moisture content of 10 to less than 20%
C: moisture content of 20% or more

The results are shown in Tables 1 and 2.

TABLE 1

| | | | | DIMEN- | | | | |
|---|---|---|---|---|---|---|---|---|
| | | BINDING | AQUEOUS | SIONAL | MASS | MASS | TENSILE | FOLDING |
| | | MATERIAL | SOLUTION | RATIO | RATIO | RATIO | STRENGTH | RESISTANCE |
| | FIBERS (A) | (B) | (C) | B/A | B/(A + B) | C/(A + B) | TEST | TEST |
| EXAMPLE 1 | CELLULOSE | FIBROIN | WATER | 0.03 | 0.20 | 0.50 | A | B |
| EXAMPLE 2 | CELLULOSE | FIBROIN | WATER | 0.50 | 0.20 | 0.50 | A | A |
| EXAMPLE 3 | CELLULOSE | FIBROIN | WATER | 1.00 | 0.20 | 0.50 | A | A |
| EXAMPLE 4 | CELLULOSE | FIBROIN | WATER | 4.00 | 0.20 | 0.50 | B | A |
| EXAMPLE 5 | CELLULOSE | FIBROIN | WATER | 0.50 | 0.01 | 0.50 | B | A |
| EXAMPLE 6 | CELLULOSE | FIBROIN | WATER | 0.50 | 0.10 | 0.50 | A | A |
| EXAMPLE 7 | CELLULOSE | FIBROIN | WATER | 0.50 | 0.40 | 0.50 | A | B |
| COMPARATIVE | CELLULOSE | FIBROIN | WATER | 0.01 | 0.20 | 0.50 | C | C |
| EXAMPLE 1 | | | | | | | | |
| COMPARATIVE | CELLULOSE | FIBROIN | WATER | 5.00 | 0.20 | 0.50 | C | A |
| EXAMPLE 2 | | | | | | | | |
| COMPARATIVE | CELLULOSE | FIBROIN | WATER | 0.50 | 0.005 | 0.50 | C | A |
| EXAMPLE 3 | | | | | | | | |
| COMPARATIVE | CELLULOSE | FIBROIN | WATER | 0.50 | 0.50 | 0.50 | A | C |
| EXAMPLE 4 | | | | | | | | |
| COMPARATIVE | CELLULOSE | STARCH | WATER | 0.50 | 0.20 | 0.50 | A | C |
| EXAMPLE 5 | | | | | | | | |
| COMPARATIVE | CELLULOSE | GELATIN | WATER | 0.50 | 0.20 | 0.50 | C | A |
| EXAMPLE 6 | | | | | | | | |
| COMPARATIVE | CELLULOSE | CASEIN | WATER | 0.50 | 0.20 | 0.50 | A | C |
| EXAMPLE 7 | | | | | | | | |

TABLE 2

| | | | | DIMEN- | | | | | |
|---|---|---|---|---|---|---|---|---|---|
| | | BINDING | AQUEOUS | SIONAL | MASS | MASS | TENSILE | FOLDING | DRYING |
| | | MATERIAL | SOLUTION | RATIO | RATIO | RATIO | STRENGTH | RESISTANCE | PROPERTY |
| | FIBERS (A) | (B) | (C) | B/A | B/(A + B) | C/(A + B) | TEST | TEST | TEST |
| EXAMPLE 8 | CELLULOSE | FIBROIN | WATER | 0.50 | 0.20 | 0.20 | B | A | A |
| EXAMPLE 9 | CELLULOSE | FIBROIN | WATER | 0.50 | 0.20 | 0.50 | A | A | A |
| EXAMPLE 10 | CELLULOSE | FIBROIN | WATER | 0.50 | 0.20 | 5.00 | A | B | B |
| EXAMPLE 11 | CELLULOSE | FIBROIN | WATER | 0.50 | 0.20 | 10.00 | B | B | B |
| COMPARATIVE | CELLULOSE | FIBROIN | WATER | 0.50 | 0.20 | 0.02 | C | C | A |
| EXAMPLE 8 | | | | | | | | | |
| COMPARATIVE | CELLULOSE | FIBROIN | WATER | 0.50 | 0.20 | 15.00 | B | C | C |
| EXAMPLE 9 | | | | | | | | | |
| EXAMPLE 12 | CELLULOSE | FIBROIN | WATER | 0.50 | 0.20 | 0.20 | B | B | A |
| EXAMPLE 13 | CELLULOSE | FIBROIN | WATER | 0.50 | 0.20 | 0.50 | A | A | A |
| EXAMPLE 14 | CELLULOSE | FIBROIN | WATER | 0.50 | 0.20 | 5.00 | A | A | A |
| EXAMPLE 15 | CELLULOSE | FIBROIN | WATER | 0.50 | 0.20 | 10.00 | A | A | B |
| COMPARATIVE | CELLULOSE | FIBROIN | WATER | 0.50 | 0.20 | 0.02 | C | C | A |
| EXAMPLE 10 | | | | | | | | | |
| COMPARATIVE | CELLULOSE | FIBROIN | WATER | 0.50 | 0.20 | 15.00 | A | B | C |
| EXAMPLE 11 | | | | | | | | | |

As shown in Table 1, in Examples 1 to 7, the results of the tensile strength and the folding resistance are excellent. On the other hand, it is found that the tensile strength and the folding resistance of Comparative Examples 1 to 7 are inferior to those of Examples 1 to 7. In addition, it is also found that when the fibroin Sb is used, the tensile strength and the folding resistance are superior to those obtained when the starch, the gelatin, or the casein is used.

As shown in Table 2, in Examples 8 to 15, the results of the tensile strength and the folding resistance are excellent. On the other hand, it is found that the tensile strength and the folding resistance of Comparative Examples 8 to 11 are inferior to those of Examples 8 to 15. Furthermore, in Examples 8 to 15, it is found that the drying property is excellent. It is found that even when the mass of the water with respect to the total mass of the mass of the fibers Sa and the mass of the fibroin Sb is small, that is, even when the amount of the water applied to the second web W2 is small, the results of the tensile strength and the folding resistance are excellent.

Hereinafter, the contents derived from the embodiments will be described.

A fiber structural body comprises: fibers; and a fibroin which binds the fibers, and when the fibers are represented by A, and the fibroin is represented by B, the following formulas (1) and (2) are satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

According to this structure, since the fibers are bound to each other with the naturally-derived fibroin, the environmental load is reduced. In addition, when the conditions described above are satisfied, a fiber structural body which secures the tensile strength and the folding resistance can be provided.

The fibers of the fiber structural body are preferably at least one selected from natural fibers and chemical fibers.

According to this structure, various fibers can be bound to each other.

The fibroin of the fiber structural body is preferably at least one selected from a material produced by an arthropod or its larva, a material derived therefrom, and an artificially produced material.

According to this structure, the naturally-derived material is used, and hence, the environmental load can be reduced. In addition, the arthropod includes, for example, order araneae, and as the larvae of arthropods, a silkworm, a bagworm, and the like may be mentioned.

The fibers of the fiber structural body each preferably have at least one of a hydroxy group, an amino group, and a carbonyl group on its surface.

According to this structure, the binding force between the fibers can be increased.

In the fiber structural body described above, the average width of the fibers in the short direction is preferably 1 to 100 μm.

According to this structure, the tensile strength and the folding resistance of the fiber structural body can be further increased.

In the fiber structural body described above, the fibers preferably have a density of 0.1 to 2.0 g/cm³.

According to this structure, the tensile strength and the folding resistance of the fiber structural body can be further increased.

A method for manufacturing a fiber structural body comprises: a mixing step of mixing fibers and a fibroin which binds the fibers to form a fiber body; a web forming step of depositing the fiber body in air to form a web; an aqueous solution applying step of applying an aqueous solution to the web; and a forming step of pressurizing and heating the web to which the aqueous solution is applied to form a fiber structural body. According to the method described above, in the mixing step, when the fibers are represented by A, and the fibroin is represented by B, the following formulas (1) and (2) are satisfied, and in the aqueous solution applying step, when moisture contained in the fiber structural body after the aqueous solution application is represented by C, the following formula (3) is satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

0.2≤mass of C/(dry mass of A with respect to total mass of fiber structural body+dry mass of B with respect to total mass of fiber structural body≤10.0 (3)

According to this structure, since the fibers are bound to each other with the naturally-derived fibroin, the environmental load is reduced. In addition, when the conditions described above are satisfied, a fiber structural body which secures the tensile strength and the folding resistance can be provided.

A method for manufacturing a fiber structural body comprises: a web forming step of depositing a fiber body containing fibers in air to form a web; an aqueous solution applying step of applying an aqueous solution containing a fibroin to the web; and a forming step of pressurizing and heating the web to which the aqueous solution is applied to form a fiber structural body. According to the method described above, in the aqueous solution applying step, when the fibers are represented by A, the fibroin is represented by B, and moisture contained in the fiber structural body after the aqueous solution application is represented by C, the following formulas (1) and (2) are satisfied.

0.01≤dry mass of B with respect to total mass of fiber structural body/(dry mass of A with respect to total mass of fiber structural body+dry mass of B with respect to total mass of fiber structural body)≤0.40 (1)

0.2≤mass of C/(dry mass of A with respect to total mass of fiber structural body+dry mass of B with respect to total mass of fiber structural body≤10.0 (2)

According to this structure, since the fibers are bound to each other with the naturally-derived fibroin, the environmental load is reduced. In addition, when the conditions described above are satisfied, a fiber structural body which secures the tensile strength and the folding resistance can be provided.

The method for manufacturing a fiber structural body described above preferably further comprises: before the aqueous solution applying step, a hydrophilic treatment step of performing a hydrophilic treatment on the surfaces of the fibers.

According to this structure, the binding strength between the fibers can be increased.

A method for manufacturing a fiber structural body comprises: a filling step of filling a mixture in which fibers, a fibroin which binds the fibers, and an aqueous solution are mixed together in a molding die; and a forming step of pressurizing and heating the filled mixture to form a fiber structural body. According to the method described above, in the filling step, when the fibers are represented by A, the fibroin is represented by B, and moisture contained in the fiber structural body after the aqueous solution application is represented by C, the following formulas (1), (2), and (3) are satisfied.

0.03≤volume average particle diameter of B/average width of A in short direction≤4.00 (1)

0.01≤dry mass of B with respect to total mass of fiber structural body/(dry mass of A with respect to total mass of fiber structural body+dry mass of B with respect to total mass of fiber structural body)≤0.40 (2)

0.2≤mass of C/(dry mass of A with respect to total mass of fiber structural body+dry mass of B with respect to total mass of fiber structural body≤10.0 (3)

According to this structure, since the fibers are bound to each other with the naturally-derived fibroin, the environmental load is reduced. In addition, when the conditions described above are satisfied, a fiber structural body which secures the tensile strength and the folding resistance can be provided.

In the forming step of the method for manufacturing a fiber structural body described above, a pressure to be applied is preferably 10 to 80 MPa.

According to this structure, the distances between the fibers are decreased, and hence, the binding strength between the fibers can be increased.

In the forming step of the method for manufacturing a fiber structural body described above, a temperature to be applied is preferably 80° C. to 230° C.

According to this structure, the fibroin between the fibers is melted, and hence, the binding strength between the fibers can be increased.

The aqueous solution of the method for manufacturing a fiber structural body described above preferably contains, besides water, one of alcohols including methyl alcohol, ethyl alcohol, isopropyl alcohol, butanol, and hexanediol and glycols including glycerin, ethylene glycol, propylene glycol, diethylene glycol, triethylene glycol, a polyethylene glycol, butylene glycol, and thiodiglycol.

According to this structure, the formation of hydrogen bonds is promoted, and hence, the binding strength between the fibers can be increased.

What is claimed is:

1. A fiber structural body comprising:
fibers; and
a fibroin which binds the fibers,
wherein when the fibers are represented by A, and the fibroin is represented by B, the following formulas (1) and (2) are satisfied
0.03≤volume average particle diameter of B/average width of A in short direction≤4.00 (1), and
0.01≤dry mass of B with respect to total mass of fiber structural body/(dry mass of A with respect to total mass of fiber structural body+dry mass of B with respect to total mass of fiber structural body)≤0.40 (2).

2. The fiber structural body according to claim 1,
wherein the fibers are at least one selected from natural fibers and chemical fibers.

3. The fiber structural body according to claim 1,
wherein the fibroin is at least one selected from a material produced by an arthropod or its larva, a material derived therefrom, and an artificially produced material.

4. The fiber structural body according to claim 1,
wherein the fibers have at least one of a hydroxy group, an amino group, and a carbonyl group on their surfaces.

5. The fiber structural body according to claim 1,
wherein the average width of the fibers in the short direction is 1 to 100 μm.

6. The fiber structural body according to claim 1,
wherein the fibers have a density of 0.1 to 2.0 g/cm³.

7. A method for manufacturing a fiber structural body comprising:
a mixing step of mixing fibers and a fibroin which binds the fibers to form a fiber body;
a web forming step of depositing the fiber body in air to form a web;
an aqueous solution applying step of applying an aqueous solution to the web; and
a forming step of pressurizing and heating the web to which the aqueous solution is applied to form a fiber structural body,
wherein in the mixing step, when the fibers are represented by A, and the fibroin is represented by B, the following formulas (1) and (2) are satisfied, and
in the aqueous solution applying step, when moisture contained in the fiber structural body after the aqueous solution application is represented by C, the following formula (3) is satisfied
0.03≤volume average particle diameter of B/average width of A in short direction≤4.00 (1),
0.01≤dry mass of B with respect to total mass of fiber structural body/(dry mass of A with respect to total mass of fiber structural body+dry mass of B with respect to total mass of fiber structural body)≤0.40 (2), and
0.2≤mass of C/(dry mass of A with respect to total mass of fiber structural body+dry mass of B with respect to total mass of fiber structural body≤10.0 (3).

8. A method for manufacturing a fiber structural body comprising:
a web forming step of depositing a fiber body containing fibers in air to form a web;
an aqueous solution applying step of applying an aqueous solution containing a fibroin to the web; and
a forming step of pressurizing and heating the web to which the aqueous solution is applied to form a fiber structural body,
wherein in the aqueous solution applying step, when the fibers are represented by A, the fibroin is represented by B, and moisture contained in the fiber structural body after the aqueous solution application is represented by C, the following formulas (1) and (2) are satisfied
0.01≤dry mass of B with respect to total mass of fiber structural body/(dry mass of A with respect to total mass of fiber structural body+dry mass of B with respect to total mass of fiber structural body)≤0.40 (1), and
0.2≤mass of C/(dry mass of A with respect to total mass of fiber structural body+dry mass of B with respect to total mass of fiber structural body≤10.0 (2).

9. The method for manufacturing a fiber structural body according to claim 7,
further comprising: before the aqueous solution applying step,
a hydrophilic treatment step of performing a hydrophilic treatment on the surfaces of the fibers.

10. A method for manufacturing a fiber structural body comprising:
a filling step of filling a mixture in which fibers, a fibroin which binds the fibers, and an aqueous solution are mixed together in a molding die; and
a forming step of pressurizing and heating the filled mixture to form a fiber structural body,
wherein in the filling step, when the fibers are represented by A, the fibroin is represented by B, and moisture contained in the fiber structural body after the aqueous solution application is represented by C, the following formulas (1), (2), and (3) are satisfied
0.03≤volume average particle diameter of B/average width of A in short direction≤4.00 (1),
0.01≤dry mass of B with respect to total mass of fiber structural body/(dry mass of A with respect to total mass of fiber structural body+dry mass of B with respect to total mass of fiber structural body)≤0.40 (2), and
0.2≤mass of C/(dry mass of A with respect to total mass of fiber structural body+dry mass of B with respect to total mass of fiber structural body≤10.0 (3).

11. The method for manufacturing a fiber structural body according to claim 7,
wherein in the forming step, a pressure to be applied is 10 to 80 MPa.

12. The method for manufacturing a fiber structural body according to claim 7,
wherein in the forming step, a temperature to be applied is 80° C. to 230° C.

13. The method for manufacturing a fiber structural body according to claim 7,
wherein the aqueous solution contains, besides water, one of alcohols including methyl alcohol, ethyl alcohol, isopropyl alcohol, butanol, and hexanediol and glycols including glycerin, ethylene glycol, propylene glycol, diethylene glycol, triethylene glycol, a polyethylene glycol, butylene glycol, and thiodiglycol.
